(19) United States
(12) Patent Application Publication
(10) Pub. No.: US 2018/0081035 A1
(43) Pub. Date: Mar. 22, 2018

(54) METHOD AND DEVICE FOR FILTERING POINT CLOUD DATA

(71) Applicant: BEIJING GREENVALLEY TECHNOLOGY CO., LTD., Beijing (CN)

(72) Inventor: Yanming GUO, Beijing (CN)

(73) Assignee: BEIJING GREENVALLEY TECHNOLOGY CO., LTD., Beijing (CN)

(21) Appl. No.: 15/377,967

(22) Filed: Dec. 13, 2016

(30) Foreign Application Priority Data
Sep. 22, 2016 (CN) 201610842203.4

(51) Int. Cl. G01S 7/48; G01S 17/89

(52) U.S. Cl. CPC G01S 7/4808; G01S 17/89

(57) ABSTRACT

Embodiments of the present invention disclose a method and device for filtering point cloud data. The method includes: transforming point cloud data into raster data, and acquiring a lowest point in each grid to serve as an initial point; performing a morphological opening operation on the raster data, to obtain an initial terrain surface; determining, for each initial point, a current initial point as a potential ground seed point when a difference between an elevation value of the current initial point and a value of a target grid into which the current initial point falls is smaller than a preset difference threshold value; constructing an initial triangular irregular network model according to the potential ground seed point; determining a ground point based on an triangular irregular network filtering algorithm according to the initial triangular irregular network model.

### CROSS-REFERENCE TO RELATED APPLICATIONS

This application claims priority to Chinese patent application No. 201610842203.4, filed on Sep. 22, 2016. The contents of that application are hereby incorporated by reference.

### TECHNICAL FIELD

Embodiments of the present invention relate to the field of data processing technologies, and in particular to a method and device for filtering point cloud data.

### BACKGROUND

Airborne light detection and ranging (LiDAR), is an emerging three-dimensional data acquisition manner, is capable of rapidly acquiring three-dimensional coordinates of ground objects with high spatial and temporal resolution, has advantages of high temporal and spatial resolution, wide observation range, high operating efficiency, capacity of penetrating through woods and the like, and is widely applied in fields of basic surveying and mapping, urban planning, three-dimensional reconstruction, forestry investigation, power line inspection and the like.

Ground points and non-ground points are simultaneously included in lidar point cloud data, and filtering refers to a process of separating the ground points and the non-ground points from the point cloud data and is a basic operation of generating a high-precision digital elevation model (DEM) and subsequent applications by utilizing point cloud data. There are many correlation researches related to filtering methods, such as morphological filtering, slope-based filtering, surface-based filtering and the like. These filtering methods have good effects when applied to regions with relatively flat terrains; however, there are poor effects in regions with a great terrain undulation or a complicated ground object style, particularly in a dense forest district, so that no ideal filtering effect can be achieved without aid of manual editing, which increases labor cost.

### SUMMARY

Embodiments of the present invention aim to provide a method and device for filtering point cloud data, so as to optimize an existing solution of filtering the airborne lidar point cloud data.

On one hand, embodiments of the present invention provide a method for filtering point cloud data, including:

transforming point cloud data into raster data, and acquiring a lowest point in each grid of the raster data to serve as an initial point;

performing a morphological opening operation on the raster data, to obtain an initial terrain surface;

determining, for each initial point, a target grid in the initial terrain surface into which the current initial point falls, calculating a difference between an elevation value of the current initial point and a value of the target grid, and determining the current initial point as a potential ground seed point when the difference is smaller than a preset difference threshold value;

constructing an initial triangular irregular network (TIN) model according to the potential ground seed point; and

determining a ground point based on an triangular irregular network filtering algorithm according to the initial triangular irregular network model.

On the other hand, embodiments of the present invention provide a device for filtering point cloud data, including:

an initial point acquisition module, configured to transform point cloud data into raster data, and acquire a lowest point in each grid of raster data to serve as an initial point;

an initial terrain surface acquisition module, configured to perform a morphological opening operation on the raster data, to obtain an initial terrain surface;

a potential ground seed point determination module, configured to determine, for each initial point, a target grid in the initial terrain surface into which the current initial point falls, calculate a difference between an elevation value of the current initial point and a value of the target grid, and determine the current initial point as a potential ground seed point when the difference is smaller than a preset difference threshold value;

an initial triangular irregular network model construction module, configured to construct an initial triangular irregular network model according to the potential ground seed point; and

a ground point determination module, configured to determine a ground point based on an triangular irregular network filtering algorithm according to the initial triangular irregular network model.

According to the solution of filtering the point cloud data provided in embodiments of the present invention, the point cloud data are transformed into the raster data and the lowest point in each grid is acquired to serve as an initial point, the raster data are subjected to a morphological opening operation and an initial terrain surface is obtained; for each initial point, an absolute elevation difference of a target grid into which the current initial point falls is determined, a potential ground seed point is screened, an initial triangular irregular network model is constructed according to the potential ground seed point, and a final ground point is determined based on an triangular irregular network filtering algorithm according to the initial triangular irregular network model. By adopting the above technical solution, ground seed points can be reasonably determined, and filtering efficiency is improved while ensuring accuracy and precision of the initial triangular irregular network model, so that the ground points in the point cloud data can be rapidly and accurately screened out.

### BRIEF DESCRIPTION OF DRAWINGS

FIG. 1 is a flow diagram illustrating a method for filtering point cloud data provided by embodiment I of the present invention;

FIG. 2 is a schematic diagram illustrating a grid provided by embodiment I of the present invention;

FIG. 3 is a schematic diagram illustrating a corrosion treatment process provided by embodiment I of the present invention;

FIG. 4 is a schematic diagram illustrating an expansion treatment process provided by embodiment I of the present invention;

FIG. 5 is a flow diagram illustrating a method for filtering point cloud data provided by embodiment II of the present invention;

FIG. 6 is a flow diagram illustrating a method for filtering point cloud data provided by embodiment III of the present invention;

FIG. 7 is a schematic diagram illustrating a triangular irregular network model provided by embodiment III of the present invention;

FIG. 8 is a schematic diagram illustrating an initial triangular irregular network model provided by embodiment III of the present invention;

FIG. 9 is a flow diagram illustrating a method for filtering point cloud data provided by embodiment IV of the present invention;

FIG. 10 is a schematic diagram illustrating performing of ground point determination based on an triangular irregular network filtering algorithm provided by embodiment IV of the present invention;

FIG. 11 is a structure block diagram illustrating a device for filtering point cloud data provided by embodiment V of the present invention;

FIG. 12 is a structure block diagram illustrating a terminal provided by embodiment VII of the present invention;

FIG. 13 is a schematic diagram illustrating encryption provided by embodiment IV of the present invention.

### DETAILED DESCRIPTION

In order to conveniently understand the technical solution and corresponding beneficial effects of embodiments of the present invention, a common solution of filtering point cloud data in the existing art is introduced first.

1) Mathematic morphological filtering, which is based on a morphological opening operation and closed operation and other operations, and is applicable to filtering of city point cloud data by filtering ground object points by virtue of a moving window; however, the mathematic morphological filtering is not applicable to filtering of point cloud data in a dense forest region, and a filtering result depends on size of a moving window.

2) A slope-based filtering algorithm, which has a basic idea that, when an elevation difference of two adjacent points is very large, a higher point of the two adjacent points may be a non-ground point since possibility of causing such an elevation difference by sudden terrain change is very low. An implementation process of the slope-based filtering algorithm is simple; however, size of a terrain slope needs to be known in advance, and a filtering result is very sensitive to slope change.

3) An triangular irregular network (TIN) filtering algorithm, which has a basic idea that a lowest point is searched by virtue of a moving window and a rough terrain surface is formed; a new ground point is added by virtue of iterative update of a distance threshold value and an angle threshold value, and the irregular triangular algorithm is poor in processing result of point cloud data of fracture and cliff

4) Clustering/segmentation-based filtering, which has a basic idea that a same class has a maximum intra-class similarity and minimum inter-class similarity; the clustering/segmentation-based algorithm has relatively good effects when applied to regions with relatively flat terrains; however, the clustering/segmentation-based algorithm has poor effects in regions with a great terrain undulation or a complicated ground object style, particularly in a dense forest district.

The technical solution of the present invention is described below in details by combining the drawings and by virtue of specific embodiments. It should be understood that, embodiments described here are only used for illustrating the present invention, not limiting the present invention. In addition, it should be noted that, in order to conveniently describe, only a part of structures related to the present invention, but not all of structures, are illustrated in the drawings.

It should be mentioned that, some exemplary embodiments are described to serve as processing or methods of flow diagram description before the exemplary embodiments are discussed in details. Although multiple steps are described into sequential processing in the flow diagrams, many steps there may be implemented concurrently, concomitantly or simultaneously. In addition, a sequence of the multiple steps may be rearranged. The processing may be ended when the operation is completed, however, the processing may also include additional steps which are not included in the drawings. The processing may correspond to methods, functions, procedures, subroutines, subprograms and the like.

### Embodiment I

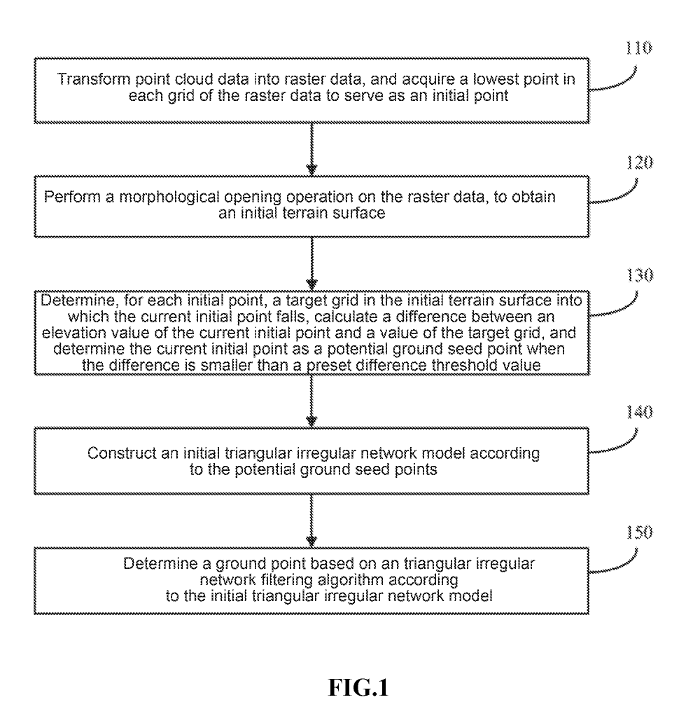

FIG. 1 is a flow diagram illustrating a method for filtering point cloud data provided by embodiment I of the present invention. The method may be executed by a device for filtering point cloud data, where the device may be implemented by software and/or hardware and generally integrated in a computer and other terminals. As shown in FIG. 1, the method includes following steps.

In step 110, point cloud data are transformed into raster data, and a lowest point in each grid of the raster data is acquired to serve as an initial point.

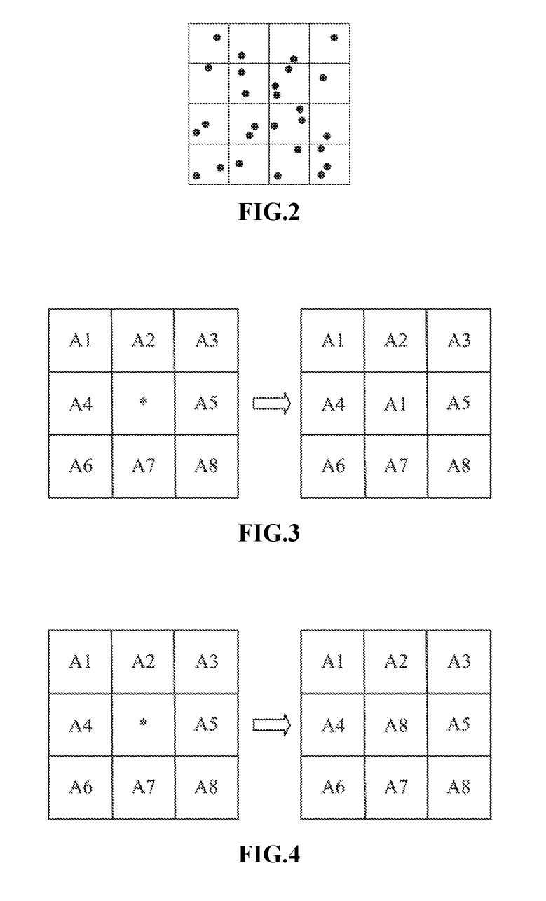

Illustratively, the point cloud data are subjected to grid processing so as to acquire grid data. For example, the point cloud data may be divided according to a rectangular grid regularization so as to acquire the grid data. In the present embodiment, precision during grid processing may be set according to actual requirements, for example, a size of each grid may be 1 m×1 m. FIG. 2 is a schematic diagram illustrating a grid provided by embodiment I of the present invention. Point cloud data are divided into a grid form after grid processing is performed. As shown in FIG. 2, black dots in the figure represent the point cloud data (all points are totally fall into an XY plane if a value Z is not considered), the data are divided with a certain interval, each sub-box may be called as a grid or a raster, and an elevation value of a lowest point in each grid in the grid data is recorded as a value of the corresponding grid.

In step 120, the raster data are subjected to a morphological opening operation, to obtain an initial terrain surface.

Illustratively, the morphological opening operation may refer to a process of corroding first and expanding afterwards, and the opening operation has effects of eliminating small objects, separating objects at fine places and smoothening a large object boundary. A closed operation corresponds to the opening operation, and may refer to a process of expanding first and corroding afterwards and has effects of filling small holes in objects, connecting with nearby objects and smoothening a boundary. FIG. 3 is a schematic diagram illustrating a corrosion treatment process provided by embodiment I of the present invention, as shown in FIG. 3, a corrosion algorithm may specifically include: each pixel of an image is scanned by using a 3*3 structural body, a center of the structural body is arranged at a to-be-processed pixel (the * in an image on the left side represents the to-be-processed pixel), a letter in each grid represents a value of the grid, a minimum value in values of eight grids around the to-be-processed pixel is assigned to the to-be-processed pixel; and assuming that the minimum value is A1, a pixel corresponding to the to-be-processed pixel in a result image (an image on the right side) is A1. FIG. 4 is a schematic diagram illustrating an expansion treatment process provided by embodiment I of the present invention, as shown in FIG. 4, an expansion algorithm may specifically include: each pixel of an image is scanned by using a 3×3 structural body, a center of the structural body is arranged at a to-be-processed pixel (the * in an image on the left side represents the to-be-processed pixel), a letter in each grid represents a value of the grid, a maximum value in values of eight grids around the to-be-processed pixel is assigned to the to-be-processed pixel; and assuming that the maximum value is A8, a pixel corresponding to the to-be-processed pixel in a result image (an image on the right side) is A8.

Illustratively, an image acquired after the raster data are subjected to the morphological opening operation is the initial terrain surface in the present embodiment.

In step 130, for each initial point, a target grid in the initial terrain surface into which the current initial point falls is determined, a difference between an elevation value of the current initial point and a value of the target grid is calculated, and the current initial point is determined as a potential ground seed point when the difference is smaller than a preset difference threshold value.

After the initial terrain surface is determined, initial points may be further screened by utilizing the initial terrain surface so as to obtain potential ground seed points for subsequent constructing of an initial triangular irregular network model. In the present embodiment, for each initial point, which grid in the initial terrain surface the current initial point is positioned in may be determined according to a horizontal coordinate of the current initial point, and the grid is recorded as a target grid. A specific screening manner may be as follows: the difference between the elevation value of the current initial point and the value of the target grid is calculated, and the current initial point is determined as a potential ground seed point when the difference is smaller than the preset difference threshold value, where the preset difference threshold value may be set according to an actual situation, for example, the preset difference threshold value may be set according to regional characteristics corresponding to the point cloud data. Illustratively, the preset difference threshold value may be set as 0.5 m.

In step 140, an initial triangular irregular network model is constructed according to the potential ground seed points.

Illustratively, every two of all points in the potential ground seed points are connected, a triangle is formed by every three adjacent points, and a triangular irregular network would be formed as a whole, so that the initial triangular irregular network model is constructed.

In step 150, a ground point is determined based on an triangular irregular network filtering algorithm according to the initial triangular irregular network model.

Illustratively, to-be-determined points may be selected from points except for the initial triangular irregular network model according to an actual situation, and whether each to-be-determined point needs to be added into the triangular irregular network model to become a ground point is sequentially determined based on the triangular irregular network filtering algorithm. A specific determination manner may be as follows: a distance from the current to-be-determined point to a plane where a target triangular grid is positioned, as well as a maximum value of included angles between connecting lines, of the current to-be-determined point and three vertexes of the target triangular grid, and a plane where the target triangular grid is positioned are calculated; and the current to-be-determined point is added into the triangular irregular network model when the distance is smaller than a preset distance threshold value and the maximum value of the included angles is smaller than a preset angle threshold value, where, for the current to-be-determined point, a triangular grid into which a horizontal coordinate of the current to-be-determined point falls may be considered as the target triangular grid.

According to the solution of filtering point cloud data provided by embodiment I of the present invention, point cloud data are transformed into raster data, and a lowest point in each grid is acquired to serve as an initial point; the raster data are subjected to a morphological opening operation to obtain an initial terrain surface; for each initial point, an absolute elevation difference of a target grid into which the current initial point falls is determined, to screen out a potential ground seed point; an initial triangular irregular network model is constructed according to the potential ground seed point; and a final ground point is determined based on an triangular irregular network filtering algorithm according to the initial triangular irregular network model. By adopting the above technical solution, ground seed points can be reasonably determined, and filtering efficiency is improved while ensuring accuracy and precision of the initial triangular irregular network model, so that ground points in the point cloud data can be rapidly and accurately screened out.

### Embodiment II

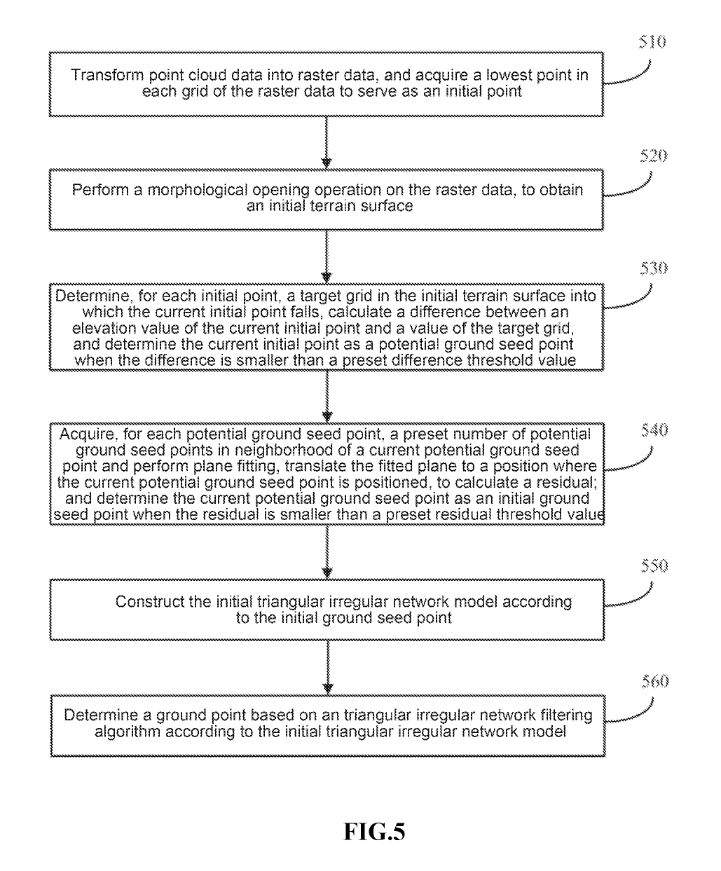

FIG. 5 is a flow diagram illustrating a method for filtering point cloud data provided by embodiment II of the present invention. The present embodiment is optimized based on the above embodiment. In the present embodiment, a step of constructing an initial triangular irregular network model according to the potential ground seed points and the initial ground seed point is optimized.

Correspondingly, the method of the present embodiment includes following steps.

In step 510, point cloud data are transformed into raster data, and a lowest point in each grid of the raster data is acquired to serve as an initial point.

In step 520, the raster data are subjected to a morphological opening operation, to obtain an initial terrain surface.

In step 530, for each initial point, a target grid in the initial terrain surface into which the current initial point falls is determined, a difference between an elevation value of the current initial point and a value of the target grid is calculated, and the current initial point is determined as a potential ground seed point when the difference is smaller than a preset difference threshold value.

In step 540, for each potential ground seed point, a preset number of potential ground seed points in neighborhood of a current potential ground seed point are acquired and are subjected to plane fitting; the fitted plane is translated to a position where the current potential ground seed point is positioned, to calculate a residual; and the current potential ground seed point is determined as an initial ground seed point when the residual is smaller than a preset residual threshold value.

In the present step, the potential ground seed points are further screened (filtered), so that accuracy of the initial triangular irregular network model can be improved. The preset number may be recorded as K, and a specific numerical value of the K is selected according to an actual situation, for example, K=10. A plane fitting manner in the present embodiment may be least-squares plane fitting.

Illustratively, the residual may be calculated by utilizing following formula:

$$r = \sqrt{\frac{{\sum }_{i = 1}^{k} {( dis ( {P}_{i} , {F}_{b} ) )}^{2}}{k}}$$

where the r represents the residual, the k represents number of neighbor points (the preset number above), the Pᵢ represents each point, the F_{b} represents the fitted plane, and the dis(Pᵢ,F_{b}) represents the distance from the point to the plane.

In step 550, the initial triangular irregular network model is constructed according to the initial ground seed point.

In step 560, a ground point is determined based on an triangular irregular network filtering algorithm according to the initial triangular irregular network model.

In embodiment II of the present invention, the potential ground seed points are further screened on the basis of the above embodiment, so that accuracy of the initial triangular irregular network model can be improved, filtering efficiency is further improved, and the ground point is determined more accurately.

### Embodiment III

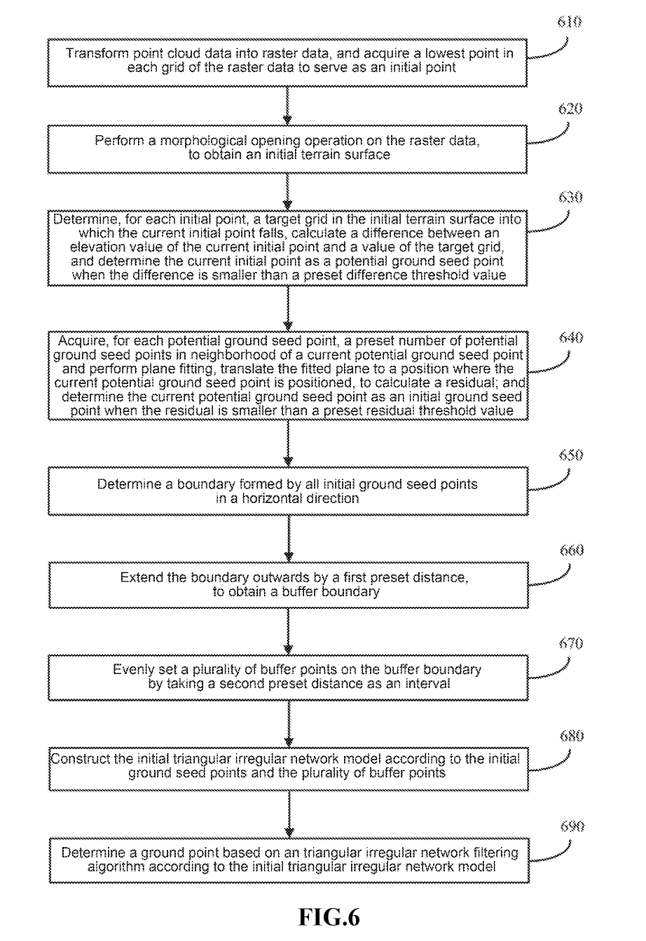

FIG. 6 is a flow diagram illustrating a method for filtering point cloud data provided by embodiment III of the present invention. The present embodiment is optimized based on the above embodiments. In the present embodiment, a step of constructing an initial triangular irregular network model according to the initial ground seed points is optimized.

Correspondingly, the method of the present embodiment includes following steps.

In step 610, point cloud data are transformed into raster data, and a lowest point in each grid of the raster data is acquired to serve as an initial point.

In step 620, the raster data are subjected to a morphological opening operation, to obtain an initial terrain surface.

In step 630, for each initial point, a target grid in the initial terrain surface into which the current initial point falls is determined, a difference between an elevation value of the current initial point and a value of the target grid is calculated, and the current initial point is determined as a potential ground seed point when the difference is smaller than a preset difference threshold value.

In step 640, for each potential ground seed point, a preset number of potential ground seed points in neighborhood of a current potential ground seed point are acquired and are subjected to plane fitting; the fitted plane is translated to a position where the current potential ground seed point is positioned, to calculate a residual; and the current potential ground seed point is determined as an initial ground seed point when the residual is smaller than a preset residual threshold value.

In step 650, a boundary formed by all initial ground seed points is determined in a horizontal direction.

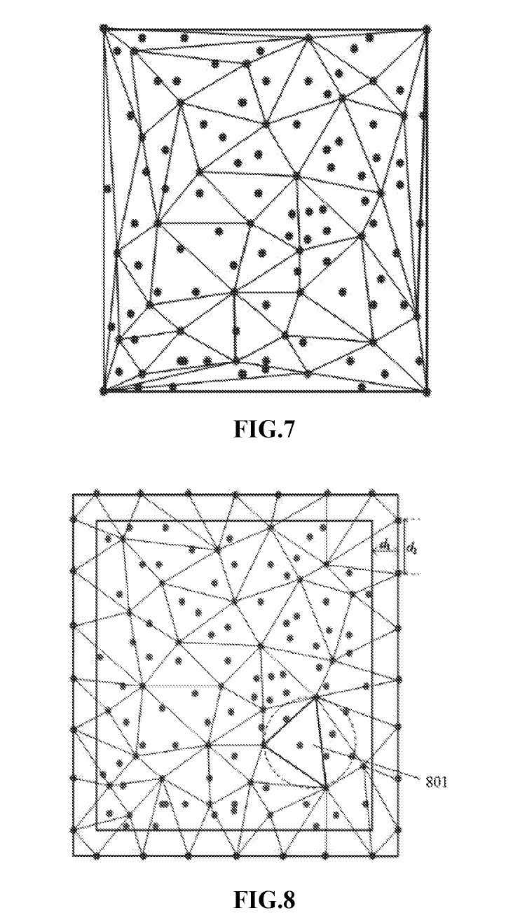

Illustratively, FIG. 7 is a schematic diagram illustrating a triangular irregular network model provided by embodiment III of the present invention. A rectangular outline in FIG. 7 is the boundary in the present step. A shape of the boundary is not defined in the present embodiment and may be determined according to distribution situation of each point in the point cloud data.

In step 660, the boundary is extended outwards by a first preset distance, so as to obtain a buffer boundary.

FIG. 8 is a schematic diagram illustrating an initial triangular irregular network model provided by embodiment III of the present invention, as shown in FIG. 8, the boundary is extended outwards by d₁ (the first preset distance) on the basis of the boundary in FIG. 7, to obtain a rectangular outline (the buffer boundary) on an outermost layer, where the first preset distance may be set according to an actual situation, for example, the first preset distance may be determined according to an area encircled by the boundary, illustratively, the distance may be 15 m. A region between the buffer boundary and the boundary may be considered as a buffer region.

In step 670, a plurality of buffer points are evenly set on the buffer boundary by taking a second preset distance as an interval.

For each buffer point, an elevation value of the current buffer point is as same as an elevation value of an initial ground seed point closest to the buffer point.

As shown in FIG. 8, the plurality of buffer points are evenly set on the buffer boundary by taking d₂ (the second preset distance) as an interval, and the elevation value of each buffer point is as same as an elevation value of a ground seed point closest to the buffer point, where the second preset distance may be set according to an actual situation, for example, the second preset distance may be determined according to a perimeter of the buffer boundary, illustratively, the distance may be 30 m.

In step 680, the initial triangular irregular network model is constructed according to the initial ground seed points and the plurality of buffer points.

A triangular irregular network model constructed under a condition that the buffer points are not added is shown in FIG. 7. A triangular irregular network model constructed under a condition that the buffer points are added is shown in FIG. 8. By contrasting FIG. 7 and FIG. 8, it can be seen that a long and narrow improper initial triangle appearing in the initial triangular irregular network model is avoided in FIG. 8, so that determination of the ground points is facilitated.

In step 690, a ground point is determined based on an triangular irregular network filtering algorithm according to the initial triangular irregular network model.

In embodiment III of the present invention, on the basis of the above embodiments, the buffer points are added when constructing the initial triangular irregular network model, so that a long and narrow improper initial triangle appearing in the initial triangular irregular network model is avoided, determination of the ground points is facilitated, and filtering efficiency is further improved.

### Embodiment IV

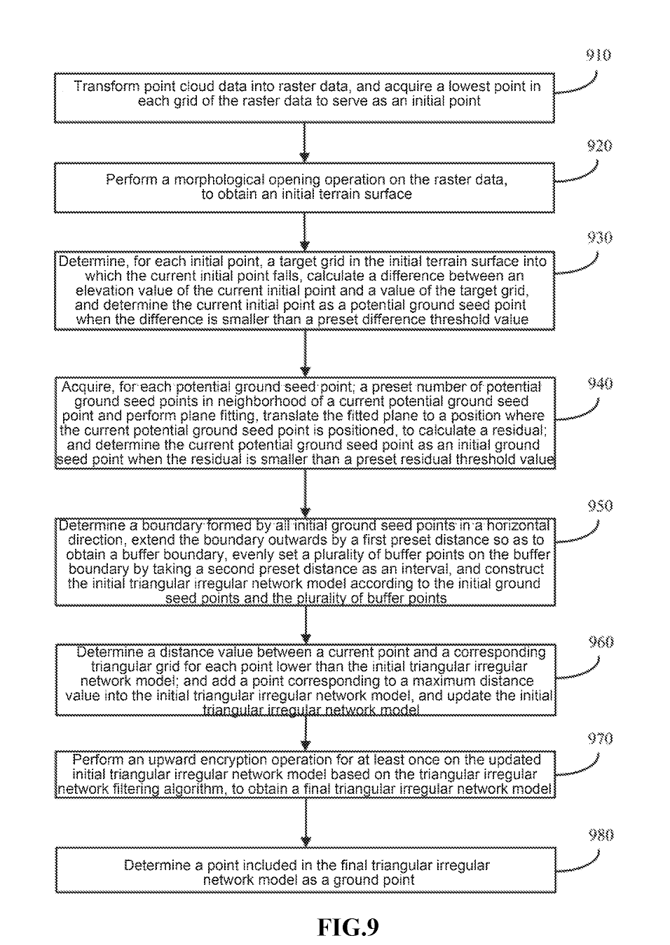

FIG. 9 is a flow diagram illustrating a method for filtering point cloud data provided by embodiment IV of the present invention. The present embodiment is optimized based on the above embodiments. In the present embodiment, a step of determining a ground point based on the triangular irregular network filtering algorithm according to the initial triangular irregular network model is optimized.

Correspondingly, the method of the present embodiment includes following steps.

In step 910, point cloud data are transformed into raster data, and a lowest point in each grid of the raster data is acquired to serve as an initial point.

In step 920, the raster data are subjected to a morphological opening operation, to obtain an initial terrain surface.

In step 930, for each initial point, a target grid in the initial terrain surface into which the current initial point falls is determined, a difference between an elevation value of the current initial point and a value of the target grid is calculated, and the current initial point is determined as a potential ground seed point when the difference is smaller than a preset difference threshold value.

In step 940, for each potential ground seed point, a preset number of potential ground seed points in neighborhood of a current potential ground seed point are acquired and are subjected to plane fitting; the fitted plane is translated to a position where the current potential ground seed point is positioned, to calculate a residual; and the current potential ground seed point is determined as an initial ground seed point when the residual is smaller than a preset residual threshold value.

In step 950, a boundary formed by all initial ground seed points is determined in a horizontal direction, the boundary is extended outwards by a first preset distance so as to obtain a buffer boundary, a plurality of buffer points are evenly set on the buffer boundary by taking a second preset distance as an interval, and the initial triangular irregular network model is constructed according to the initial ground seed points and the plurality of buffer points,

where, for each buffer point, an elevation value of the current buffer point is as same as an elevation value of an initial ground seed point closest to the buffer point.

In step 960, a distance value between a current point and a corresponding triangular grid is determined for each point lower than the initial triangular irregular network model; and a point corresponding to a maximum distance value is added into the initial triangular irregular network model, and the initial triangular irregular network model is updated.

In the present embodiment, in order to avoid missing ground points, the initial triangular irregular network model may be taken as a boundary surface, so as to firstly determine whether there is a missing ground point below the boundary surface, that is, downward encryption is performed firstly. A specific determination manner may be as follows: for each point lower than the initial triangular irregular network model, a distance value between the current point and a corresponding triangular grid is determined, a point corresponding to a maximum distance value is added into the initial triangular irregular network model, and the initial triangular irregular network model is updated.

In step 970, the updated initial triangular irregular network model is subjected to an upward encryption operation for at least once based on the triangular irregular network filtering algorithm, to obtain a final triangular irregular network model.

Specifically, the present step may include the following: to-be-determined points above the current triangular irregular network model are sorted according to a sequence from a smaller elevation value to a greater elevation value so as to obtain a to-be-determined point sequence; to-be-determined points corresponding to an encryption operation of this time are determined according to the to-be-determined point sequence; for each to-be-determined point, whether to add the current to-be-determined point into the current triangular irregular network model is judged based on the triangular irregular network filtering algorithm if there is no to-be-determined point, which is added during an encryption of this time, in a target triangular grid corresponding to the current to-be-determined point; where, for a first encryption operation, the current triangular irregular network model is the updated initial triangular irregular network model; the current triangular irregular network model is updated; and if the updated triangular irregular network model is as same as a triangular irregular network model before updating, encryption is stopped, and the updated triangular irregular network model is taken as a final triangular irregular network model, where the upward encryption operation for at least once may be understood as an upward iteration encryption operation.

In each encryption process of the upward encryption, each to-be-determined point may be sequentially determined according to the sequence from a smaller elevation value to a greater elevation value, if a to-be-determined point has been added into a triangular grid (that is, a to-be-determined point which is determined as a ground point through prior determination), no new ground point would be added in the triangular grid in the encryption process of this time, the triangular irregular network model is updated after the encryption of this time is completed, and then a next encryption is performed, so that calculating amount is reduced, and encryption efficiency is improved.

Furthermore, the judging whether to add the current to-be-determined point into the current triangular irregular network model based on the triangular irregular network filtering algorithm may specifically include the following: a distance from the current to-be-determined point to a plane where a target triangular grid is positioned, as well as a maximum value of included angles between connecting lines, of the current to-be-determined point and three vertexes of the target triangular grid, and a plane where the target triangular grid is positioned are calculated; and the current to-be-determined point is added into the current triangular irregular network model when the distance is smaller than a preset distance threshold value and the maximum value of the included angles is smaller than a preset angle threshold value.

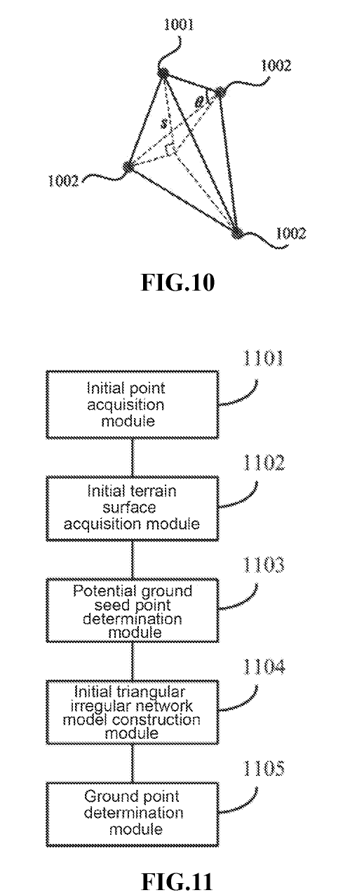

As shown in FIG. 8, a point in a triangular grid selected by a circular curve is the current to-be-determined point, and the triangular grid is the target triangular grid 801. FIG. 10 is a schematic diagram illustrating performing of ground point determination based on an triangular irregular network filtering algorithm provided by embodiment IV of the present invention, as shown in FIG. 10, a distance S from a to-be-determined point 1001 to the plane where the target triangular grid is positioned is calculated; and, included angles θ₁, θ₂ and θ₃ between connecting lines, of the to-be-determined point 1001 and three vertexes 1002 of the target triangular grid, and the plane where the target triangular grid is positioned are calculated, a maximum included angle θ in the three included angles is found by comparison, and the to-be-determined point is added into the current triangular irregular network model when S is smaller than the preset distance threshold value and θ is smaller than the preset angle threshold value.

It is indicated that there is no new to-be-determined point meeting a condition for adding into the triangular irregular network model if the updated triangular irregular network model is as same as the triangular irregular network model before updating, then encryption may be stopped at this moment, and the updated triangular irregular network model is taken as the final triangular irregular network model.

In step 980, a point included in the final triangular irregular network model is determined as a ground point.

It should be understood that, a buffer point included in the final triangular irregular network model is an imaginary point which is not a ground point, and residual points are ground points.

In the present embodiment, a manner of downward encryption first and upward encryption afterwards is adopted, so that encryption precision and accuracy are improved. FIG. 13 is a schematic diagram illustrating encryption provided by embodiment IV of the present invention, as shown in FIG. 13, black solid points are ground seed points, P1, P2, P3, P4 and P5 are to-be-determined points. P2 would be added into the triangular irregular network model if the upward encryption is directly performed and judgment is performed according to the distance and angle threshold values, and a terrain surface obtained under such condition would be higher that a real terrain surface; however, P3 would be added into the triangular irregular network model if downward encryption is performed first, and P4 and P5 would also be added during the subsequent upward encryption. Thus, in conclusion, the manner of downward encryption first and upward encryption afterwards in the present embodiment is capable of determining the ground points more accurately.

In embodiment IV, on the basis of the above embodiments, in order to avoid missing ground points, determination is performed by adopting the manner of downward encryption first and upward encryption afterwards, the triangular irregular network model is gradually encrypted, so that precision and accuracy are improved.

On the basis of the above embodiments, an Improved Progressive Triangulated Irregular Network Densification (IPTD) algorithm is provided, and the algorithm can filter point cloud data by executing various steps in the above embodiments. The IPTD filtering algorithm provided by embodiments of the present invention has been verified in 15 different forest districts, and these research regions have different terrain undulations (elevation and slope) and vegetation conditions (canopy cover degrees and tree height). Compared with seven existing filtering algorithms (such as morphological filtering, a slope-based filtering algorithm, an interpolation-based filtering algorithm and the like), the IPTD filtering algorithm has a highest precision in nine of the research regions.

### Embodiment V

FIG. 11 is a structure block diagram illustrating a device for filtering point cloud data provided by embodiment V of the present invention. The device may be implemented by software and/or hardware and is generally integrated in a computer and other terminals and may filter point cloud data by executing the method for filtering the point cloud data. As shown in FIG. 11, the device includes: an initial point acquisition module 1101, an initial terrain surface acquisition module 1102, a potential ground seed point determination module 1103, an initial triangular irregular network model construction module 1104 and a ground point determination module 1105.

The initial point acquisition module 1101 is configured to transform point cloud data into raster data, and acquire a lowest point in each grid of the raster data to serve as an initial point; the initial terrain surface acquisition module 1102 is configured to perform a morphological opening operation on the raster data, to obtain an initial terrain surface; the potential ground seed point determination module 1103 is configured to determine a target grid in the initial terrain surface into which the current initial point falls, calculate a difference between an elevation value of the current initial point and a value of the target grid for each initial point, and determine the current initial point as a potential ground seed point when the difference is smaller than a preset difference threshold value; the initial triangular irregular network model construction module 1104 is configured to construct an initial triangular irregular network model according to the potential ground seed point; and the ground point determination module 1105 is configured to determine a ground point based on an triangular irregular network filtering algorithm according to the initial triangular irregular network model.

According to the device for filtering the point cloud data provided by embodiment V of the present invention, the ground seed points can be reasonably determined, and filtering efficiency is improved while ensuring accuracy and precision of the initial triangular irregular network model, so that ground points in the point cloud data can be rapidly and accurately screened out.

On the basis of the above embodiments, the initial triangular irregular network model construction module may include:

an initial ground seed point determination unit, configured to acquire a preset number of potential ground seed points in neighborhood of a current potential ground seed point and perform plane fitting for each potential ground seed point, translate the fitted plane to a position where the current potential ground seed point is positioned, to calculate a residual, and determine the current potential ground seed point as an initial ground seed point when the residual is smaller than a preset residual threshold value;

a model construction unit, configured to construct the initial triangular irregular network model according to the initial ground seed point.

On the basis of the above embodiments, the model construction unit may include:

a boundary determination subunit, configured to determine a boundary formed by all initial ground seed points in a horizontal direction;

a boundary extension subunit, configured to extend the boundary outwards by a first preset distance, so as to obtain a buffer boundary;

a buffer point setting subunit, configured to evenly set a plurality of buffer points on the buffer boundary by taking a second preset distance as an interval, where, for each buffer point, an elevation value of the current buffer point is as same as an elevation value of an initial ground seed point closest to the buffer point; and

a model construction subunit, configured to construct the initial triangular irregular network model according to the initial ground seed points and the plurality of buffer points.

On the basis of the above embodiments, the ground point determination module may include:

a downward encryption unit, configured to determine a distance value between a current point and a corresponding triangular grid for each point lower than the initial triangular irregular network model; add a point corresponding to a maximum distance value into the initial triangular irregular network model, and update the initial triangular irregular network model;

an upward encryption unit, configured to perform a upward encryption operation on the updated initial triangular irregular network model for at least once based on the triangular irregular network filtering algorithm, to obtain a final triangular irregular network model; and

a ground point determination unit, configured to determine a point included in the final triangular irregular network model as a ground point.

On the basis of the above embodiments, the encryption unit may include:

a sorting subunit, configured to sort to-be-determined points above the current triangular irregular network model according to a sequence from a smaller elevation value to a greater elevation value, so as to obtain a to-be-determined point sequence;

a to-be-determined point determination subunit, configured to determine to-be-determined points corresponding to an encryption operation of this time according to the to-be-determined point sequence;

an encryption subunit, configured to judge whether to add the current to-be-determined point into the current triangular irregular network model based on the triangular irregular network filtering algorithm if there is no to-be-determined point, which is added during an encryption of this time, in a target triangular grid corresponding to the current to-be-determined point for each to-be-determined point; where, for a first encryption operation, the current triangular irregular network model is the updated initial triangular irregular network model;

a model updating subunit, configured to update the current triangular irregular network model; and

a final triangular irregular network model determination subunit, configured to control the encryption subunit to stop, if the updated triangular irregular network model is as same as a triangular irregular network model before updating, encrypting, and take the updated triangular irregular network model as a final triangular irregular network model.

### Embodiment VI

Embodiments of the present invention further provide a storage medium including a computer executable instruction, and the computer executable instruction is configured to, when executed by a computer processor, execute the method for filtering point cloud data, including:

point cloud data are transformed into raster data, and a lowest point in each grid of the raster data is acquired to serve as an initial point; the raster data are subjected to a morphological opening operation, to obtain an initial terrain surface; for each initial point, a target grid in the initial terrain surface into which the current initial point falls is determined, a difference between an elevation value of the current initial point and a value of the target grid is calculated, and the current initial point is determined as a potential ground seed point when the difference is smaller than a preset difference threshold value; an initial triangular irregular network model is constructed according to the potential ground seed point; a ground point is determined based on an triangular irregular network filtering algorithm according to the initial triangular irregular network model.

Optionally, the computer executable instruction may be further configured to, when executed by a computer processor, execute a technical solution of the method for filtering point cloud data provided by any embodiment of the present invention.

Through the above description of the implementation manners, those skilled in the art may understand clearly that the present invention may be realized by the aid of software and necessary universal hardware, or through hardware certainly, however, the former is a better implementation manner in many cases. On the basis of such understanding, the technical solution of the present invention may be embodied in the form of a software product in essence or in a part contributing the existing art, and the computer software product may be stored in a computer-readable storage medium, such as a floppy disk of the computer, a Read-Only Memory (ROM), a Random Access Memory (RAM), a flash, a hard disk or an optical disk and the like, including several instructions for enabling a computer device (may be a personal computer, a server, or a network device and the like) to execute the method of each embodiment of the prevent invention.

### Embodiment VII

Embodiment VII of the present invention provides a terminal, including a device for filtering point cloud data provided by any embodiment of the present invention.

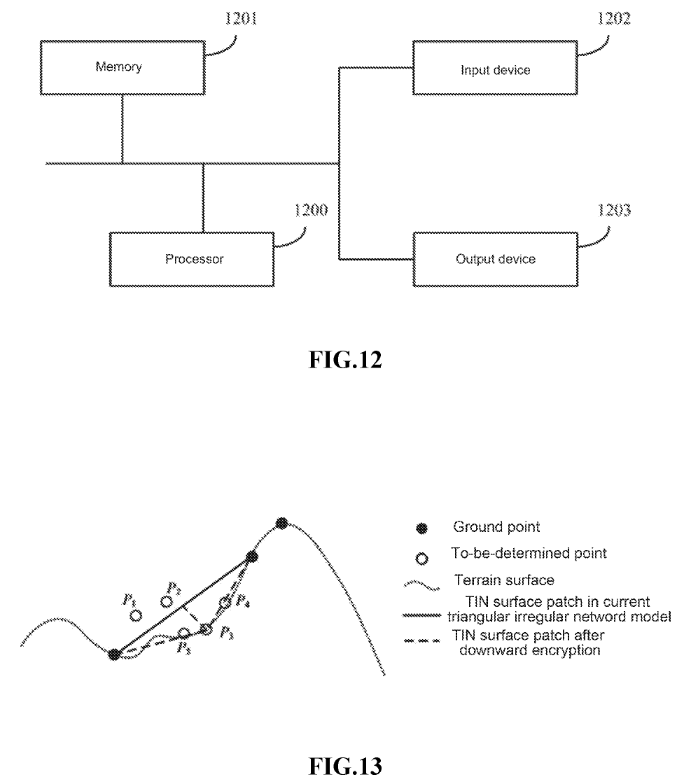

Specifically, FIG. 12 is a structure block diagram illustrating a terminal provided by embodiment VII of the present invention, as shown in FIG. 12, the present embodiment of the present invention provides a terminal, including a processor 1200, a memory 1201, an input device 1202 and an output device 1203; one or more processors 1200 may be arranged in the terminal, and one processor 1200 is taken as an example in FIG. 12; and the processor 1200, memory 1201, input device 1202 and output device 1203 in the terminal may be connected by buses or in other manners, and connection by virtue of the buses is taken as an example in FIG. 12.

The memory 1201 serves as a computer-readable storage medium which may be configured to store software programs, computer executable programs and modules, such as program instructions/modules which correspond to a method for filtering point cloud data in embodiments of the present invention (such as the initial point acquisition module 1101, the initial terrain surface acquisition module 1102, the potential ground seed point determination module 1103, the initial triangular irregular network model construction module 1104 and the ground point determination module 1105). The processor 1200 is enabled to execute various functional applications and data processing of the terminal by operating the software programs, instructions and modules stored in the memory 1201, that is, the above method for filtering point cloud data is implemented.

The memory 1201 may mainly include a program storage region and a data storage region, where the program storage region may be configured to store application programs needed by an operating system and at least one function; and the data storage region may be configured to store data established according to use of the terminal and the like. In addition, the memory 1201 may include a high-speed random access memory and non-volatile memories, such as at least one disk storage device, a flash memory device or other non-volatile solid state storage devices. In some embodiments, the memory 1201 may further include memories which are remotely set relative to the processor 1200. The remote memories may be connected to the terminal by virtue of a network. Examples of the above network may include but not limited to Internet, Intranet, a local area network, a mobile communication network and a combination thereof.

The input device 1202 may be configured to receive the input digit or character information and generate key signal input related to user setting and function control of the terminal. The output device 1203 may include a display screen and other display devices.

The device for filtering point cloud data, storage medium and terminal provided by the above embodiments may execute the method for filtering point cloud data provided by embodiments of the present invention, and have corresponding functional modules for executing the method as well as beneficial effects. Technical details which are not described in the above embodiments may refer to the method for filtering point cloud data provided by any embodiment of the present invention.

It should be noted that, the above descriptions are only embodiments and applied technical principles of the present invention. Those ordinary skilled in the art should understand that the present invention is not limited to the specific embodiments here, and may perform various obvious modifications, readjustments and replacements without departing from the protection scope of the present invention. Therefore, although the present invention is illustrated in detail with reference to the above embodiments, the present invention is not limited to the above embodiments and may include more other equivalent embodiments on the premise of not departing from the concept of the present invention, and the scope of the present invention is determined by the scope of the attached claims.

What is claimed is:

1. A method for filtering point cloud data, comprising:
transforming point cloud data into raster data, and acquiring a lowest point in each grid of raster data to serve as an initial point;
performing a morphological opening operation on the raster data, to obtain an initial terrain surface;
determining, for each initial point, a target grid in the initial terrain surface into which the current initial point falls, calculating a difference between an elevation value of the current initial point and a value of the target grid, and determining the current initial point as a potential ground seed point when the difference is smaller than a preset difference threshold value;
constructing an initial triangular irregular network model according to the potential ground seed point; and
determining a ground point based on an triangular irregular network filtering algorithm according to the initial triangular irregular network model.

2. The method according to claim 1, wherein the constructing an initial triangular irregular network model according to the potential ground seed point, comprises:
Acquiring, for each potential ground seed point, a preset number of potential ground seed points in neighborhood of a current potential ground seed point and performing plane fitting, translating the fitted plane to a position where the current potential ground seed point is positioned, to calculate a residual, and determining the current potential ground seed point as an initial ground seed point when the residual is smaller than a preset residual threshold value; and
constructing an initial triangular irregular network model according to the initial ground seed point.

3. The method according to claim 2, wherein the constructing an initial triangular irregular network model according to the initial ground seed point, comprises:
determining a boundary formed by all initial ground seed points in a horizontal direction;
extending the boundary outwards by a first preset distance, so as to obtain a buffer boundary;
evenly setting a plurality of buffer points on the buffer boundary by taking a second preset distance as an interval; wherein for each buffer point, an elevation value of the current buffer point is as same as an elevation value of an initial ground seed point closest to the buffer point; and
constructing the initial triangular irregular network model according to the initial ground seed points and the plurality of buffer points.

4. The method according to claim 1, wherein the determining a ground point based on an triangular irregular network filtering algorithm according to the initial triangular irregular network model, comprises:
determining a distance value between a current point and a corresponding triangular grid for each point lower than the initial triangular irregular network model;
adding a point corresponding to a maximum distance value into the initial triangular irregular network model, and updating the initial triangular irregular network model;
performing an upward encryption operation on the updated initial triangular irregular network model for at least once based on the triangular irregular network filtering algorithm, to obtain a final triangular irregular network model; and
determining a point included in the final triangular irregular network model as a ground point.

5. The method according to claim 4, wherein the performing an upward encryption operation on the updated initial triangular irregular network model for at least once based on the triangular irregular network filtering algorithm so as to obtain a final triangular irregular network model, comprises:
sorting to-be-determined points above the current triangular irregular network model according to a sequence from a smaller elevation value to a greater elevation value, to obtain a to-be-determined point sequence;
determining to-be-determined points corresponding to an encryption operation of this time according to the to-be-determined point sequence;
judging, for each to-be-determined point, whether to add the current to-be-determined point into the current triangular irregular network model based on the triangular irregular network filtering algorithm if there is no to-be-determined point, which is added during an encryption of this time, in a target triangular grid corresponding to the current to-be-determined point; wherein, for a first encryption operation, the current triangular irregular network model is the updated initial triangular irregular network model;
updating the current triangular irregular network model; and
stopping, if the updated triangular irregular network model is as same as a triangular irregular network model before updating, encryption, and taking the updated triangular irregular network model as a final triangular irregular network model.

6. The method according to claim 5, wherein the judging whether to add the current to-be-determined point into the current triangular irregular network model based on the triangular irregular network filtering algorithm, comprises:
calculating a distance from the current to-be-determined point to a plane where a target triangular grid is positioned, as well as a maximum value of included angles between connecting lines, of the current to-be-determined point and three vertexes of the target triangular grid, and a plane where the target triangular grid is positioned; and
adding the current to-be-determined point into the current triangular irregular network model when the distance is smaller than a preset distance threshold value and the maximum value of the included angles is smaller than a preset angle threshold value.

7. A device for filtering point cloud data, comprising:
an initial point acquisition module, configured to transform point cloud data into raster data, and acquire a lowest point in each grid of raster data to serve as an initial point;
an initial terrain surface acquisition module, configured to perform a morphological opening operation on the raster data, to obtain an initial terrain surface;
a potential ground seed point determination module, configured to determine, for each initial point, a target grid in the initial terrain surface into which the current initial point falls, calculate a difference between an elevation value of the current initial point and a value of the target grid, and determine the current initial point as a potential ground seed point when the difference is smaller than a preset difference threshold value;
an initial triangular irregular network model construction module, configured to construct an initial triangular irregular network model according to the potential ground seed point; and
a ground point determination module, configured to determine a ground point based on an triangular irregular network filtering algorithm according to the initial triangular irregular network model.

8. The device according to claim 7, wherein the initial triangular irregular network model construction module comprises:
an initial ground seed point determination unit, configured to acquire, for each potential ground seed point, a preset number of potential ground seed points in neighborhood of a current potential ground seed point and perform plane fitting, translate the fitted plane to a position where the current potential ground seed point is positioned, to calculate a residual, and determine the current potential ground seed point as an initial ground seed point when the residual is smaller than a preset residual threshold value; and
a model construction unit, configured to construct an initial triangular irregular network model according to the initial ground seed point.

9. The device according to claim 8, wherein the model construction unit comprises:
a boundary determination subunit, configured to determine a boundary formed by all initial ground seed points in a horizontal direction;
a boundary extension subunit, configured to extend the boundary outwards by a first preset distance, so as to obtain a buffer boundary;
a buffer point setting subunit, configured to evenly set a plurality of buffer points on the buffer boundary by taking a second preset distance as an interval;
wherein, for each buffer point, an elevation value of the current buffer point is as same as an elevation value of an initial ground seed point closest to the buffer point; and
a model construction subunit, configured to construct the initial triangular irregular network model according to the initial ground seed points and the plurality of buffer points.

10. The device according to claim 7, wherein the ground point determination module comprises:
a downward encryption unit, configured to determine a distance value between a current point and a corresponding triangular grid for each point lower than the initial triangular irregular network model; add a point corresponding to a maximum distance value into the initial triangular irregular network model, and update the initial triangular irregular network model;
an upward encryption unit, configured to perform an upward encryption operation on the updated initial triangular irregular network model for at least once based on the triangular irregular network filtering algorithm, to obtain a final triangular irregular network model; and
a ground point determination unit, configured to determine a point included in the final triangular irregular network model as a ground point.

11. The device according to claim 10, wherein the encryption unit comprises:
a sorting subunit, configured to sort to-be-determined points above the current triangular irregular network model according to a sequence from a smaller elevation value to a greater elevation value, to obtain a to-be-determined point sequence;
a to-be-determined point determination subunit, configured to determine to-be-determined points corresponding to an encryption operation of this time according to the to-be-determined point sequence;
an encryption subunit, configured to judge, for each to-be-determined point, whether to add the current to-be-determined point into the current triangular irregular network model based on the triangular irregular network filtering algorithm if there is no to-be-determined point, which is added during an encryption of this time, in a target triangular grid corresponding to the current to-be-determined point; wherein, for a first encryption operation, the current triangular irregular network model is the updated initial triangular irregular network model;
a model updating subunit, configured to update the current triangular irregular network model; and
a final triangular irregular network model determination subunit, configured to control the encryption subunit to stop, if the updated triangular irregular network model is as same as a triangular irregular network model before updating, encrypting, and take the updated triangular irregular network model as a final triangular irregular network model.

12. The device according to claim 11, wherein the judging whether to add the current to-be-determined point into the current triangular irregular network model based on the triangular irregular network filtering algorithm, comprises:
calculating a distance from the current to-be-determined point to a plane where a target triangular grid is positioned, as well as a maximum value of included angles between connecting lines, of the current to-be-determined point and three vertexes of the target triangular grid, and a plane where the target triangular grid is positioned; and
adding the current to-be-determined point into the current triangular irregular network model when the distance is smaller than a preset distance threshold value and the maximum value of the included angles is smaller than a preset angle threshold value.
